(19) United States
(12) Patent Application Publication
(10) Pub. No.: US 2014/0113044 A1
(43) Pub. Date: Apr. 24, 2014

(54) METHODS AND SYSTEMS RELATED TO A HOT COOKING APPARATUS SILICONE COVER

(71) Applicant: Dennis J. McIntire, Fort Worth, TX (US)

(72) Inventor: Dennis J. McIntire, Fort Worth, TX (US)

(21) Appl. No.: 13/838,483

(22) Filed: Mar. 15, 2013

Related U.S. Application Data
(60) Provisional application No. 61/649,591, filed on May 21, 2012.

(51) Int. Cl. A47J 37/07

(52) U.S. Cl. CPC A47J 37/0786
USPC 426/416; 150/165

(57) ABSTRACT

Hot Cooking Apparatus Silicone Cover. At least some of the example embodiments are methods including: placing food within a cooking apparatus; heating the cooking apparatus; removing the food from the cooking apparatus; and then draping a silicone sheet on top of the cooking apparatus, the draping of the cooking apparatus covers the cooking apparatus, the draping done while the cooking apparatus has an exterior metallic surface with a temperature of at least 140 degrees Fahrenheit.

### CROSS-REFERENCE TO RELATED APPLICATIONS

This application claims the benefit of U.S. Provisional Application No. 61/649,591 filed 21 May 2012 titled “A High Temperature Silicone Rubber Cover for Hot Grills, Stoves, or Other Cooking Devices,” the disclosure of which is incorporated herein by reference as if reproduced in full below.

### BACKGROUND

Outdoor weather conditions can accelerate degradation of an outdoor grill, and thus the grill may need to be protected by a cover; however, covers can be inefficient and susceptible to damage. Damaged covers may result in the frequent purchase of new covers or may result in the grill owner electing not to cover the grill at all, thus leading to a faster deterioration of the condition of the grill. Thus, any advancement in grill protection is advantageous.

### BRIEF DESCRIPTION OF THE DRAWINGS

For a detailed description of exemplary embodiments, reference will now be made to the accompanying drawings in which:

FIG. 1 shows a perspective view of cooking apparatus in accordance with at least some embodiments;

FIG. 2A shows an overhead view of a cooking apparatus cover in accordance with at least some embodiments;

FIG. 2B shows an overhead view of a cooking apparatus cover in accordance with at least some embodiments;

FIG. 2C shows an overhead view of a cooking apparatus cover in accordance with at least some embodiments;

FIG. 3A shows a perspective view cooking apparatus draped with a cooking apparatus cover in accordance with at least some embodiments;

FIG. 3B shows a perspective view of a cooking apparatus draped with a cooking apparatus cover in accordance with at least some embodiments; and

FIG. 4 shows, in block diagram form, a method in accordance with at least some embodiments.

### NOTATION AND NOMENCLATURE

Certain terms are used throughout the following description and claims to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct connection.

“Cover” or “covers” shall mean to hide from view at least a portion of a cooking apparatus with a silicone sheet such that less than 80% of the cooking apparatus is visible to person standing on the same horizontal surface as the cooking apparatus.

“Drape,” in the context of a silicone sheet, shall mean to arrange the silicone sheet in such a way that a portion of the silicone sheet touches the top outer portion of the cooking apparatus, and the remaining portion of the silicone sheet hangs downward from the portion of the sheet touching the cooking apparatus.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to a heat-resistant and weather-resistant cooking apparatus cover. The developmental context is a heat-resistant cover which may be placed over a heated outdoor grill, and thus the specification will be based on that developmental context; however, the developmental context shall not be read as a limitation as to the applicability of the various embodiments. The specification first turns to a high level overview.

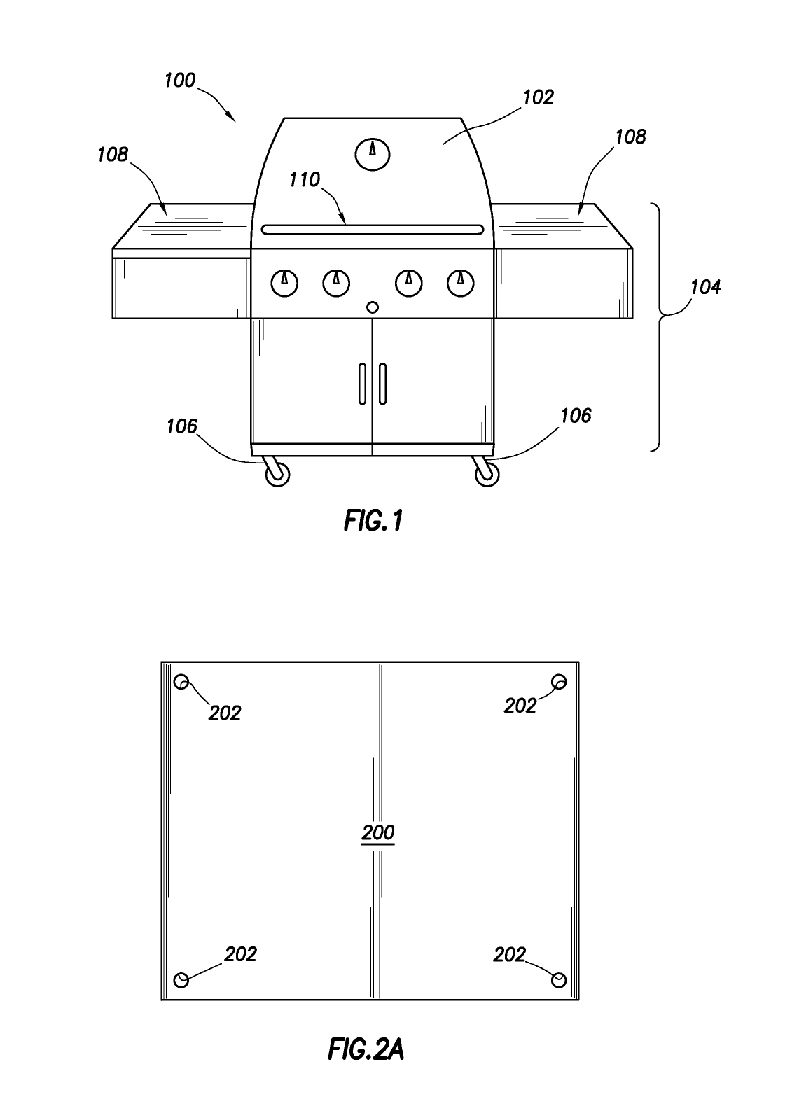

FIG. 1 shows an example outdoor grill 100 in accordance with at least some embodiments. In particular, outdoor grill 100 may comprise a metallic top section 102, a bottom portion 104, legs 106, side shelves 108 and a top cover handle 110 used to open and close the grill without touching the hot metallic top section 102. In one example scenario, the grill user turns on the outdoor grill to begin heating the cooking surface. After the grill has reached a desired temperature, the user places the food on the grill, cooking the food. By the time the food has been removed from the grill, both the inner sections and the outer surfaces of the grill may have reached temperatures too high for the user to touch with his bare skin. For example, the top section 102 of the grill may be over 140 degrees Fahrenheit, such that any prolonged skin-to-grill surface contact may result in a skin burn.

The user may seek to cover the grill while it is still hot for a variety of reasons. In one example situation, the user may want to help protect him or others from receiving burns resulting from accidentally touching the hot grill. In another example situation, the user may want to protect the grill from various weather-related elements, such as rain, wind, and dust, and does not want to wait until the grill 100 has cooled down, lest covering the grill be a task that is forgotten. In both of these example situations, the temperature of the hot grill 100 may make it difficult to cover the grill; namely, if the grill cover is made from a material with a low melting point, the cover cannot be placed on the grill without the material melting onto portions of the hot surfaces. In another scenario, the cover may be made of a material such as canvas, which may be able to be placed over the hot grill, but may become dirty and brittle over time, and thus susceptible to damage. However, a grill cover made from a high-temperature resistant silicone polymer is able to be placed over a hot grill without worry of the cover melting onto the surface of the grill. In addition, the high-temperature resistant silicone polymer is resistant to cold weather and may be easily wiped off or rinsed off.

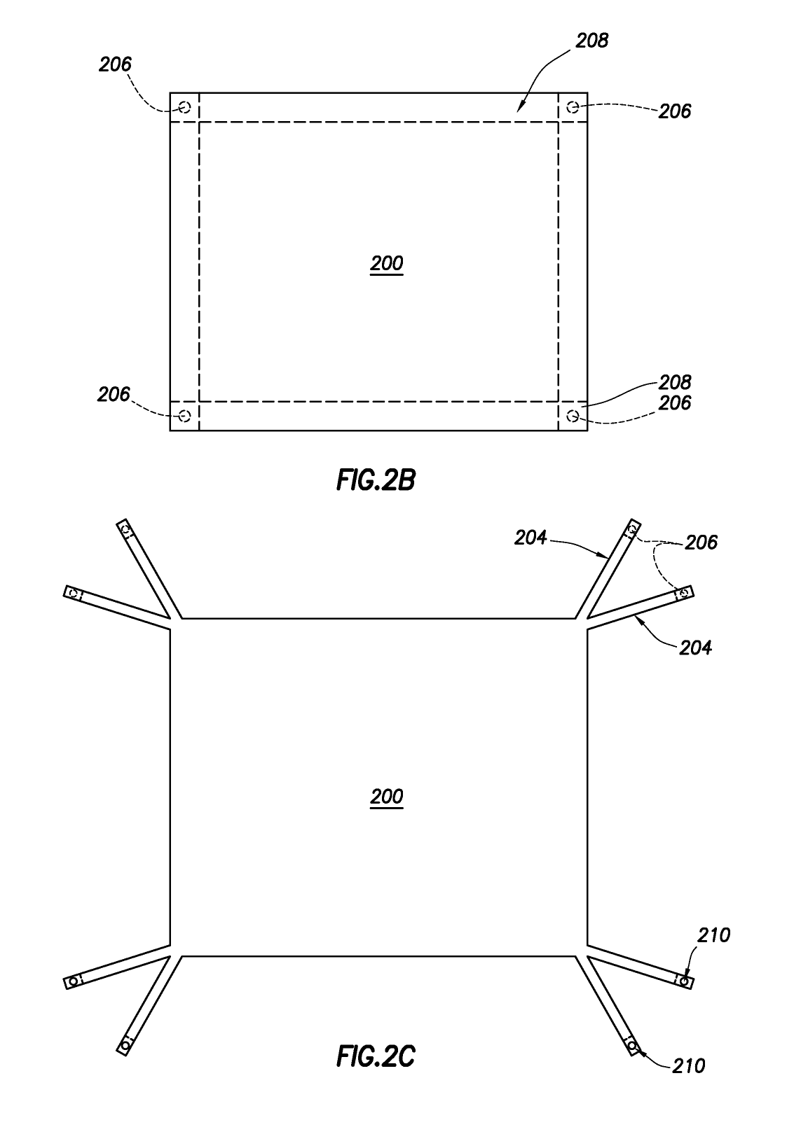

FIG. 2A shows grill cover 200, where grill cover 200 is made out of a high-temperature resistant silicone polymer. In one embodiment, the high-temperature resistant silicone polymer grill cover 200 will have a smooth surface on both the topside and the underside of the grill cover. In another embodiment, the grill cover 200 may be imprinted with ridges and valleys which may aid in providing friction to hold the grill cover onto the grill 100. Additionally, the silicone polymer may have a melting point at least as high as 750 degrees Fahrenheit such that, if placed on top of a hot grill, the silicone grill cover 200 will not suffer degradation or deformation. In one embodiment, the grill cover 200 may have a thickness as thin as 1/16 of an inch. In another embodiment, the grill cover may have a thickness as thick as 5/16 of an inch. Although the thickness of the silicone grill cover 200 may vary, the silicone grill cover is thin enough and malleable enough to be draped on top of the outdoor grill and, at least in part, conform to the upper portion of the grill to cover the outer surface of the grill.

When the silicone grill cover 200 is draped on top of grill 100, at least a portion of the underside of the silicone grill cover touches the top surface 102 of the grill. In one embodiment, the portion of the silicone grill cover 200 which does not touch the top surface 102 of the grill 100, hangs around the bottom portion 104 of grill 100. In this embodiment, the silicone grill cover 200 is secured to the grill 100 by way of a combination of the weight of the silicone grill cover 200 and gravity. In other embodiments, silicone grill cover 200 may be secured to grill 100 by way of a plurality of attachment devices.

Referring again to FIG. 2A, the silicone grill cover 200 may comprise a set of holes 202 used to aid in securing the grill cover 200 to the grill 100. Although four example holes 202 are shown as located in the four corners of an example rectangular-shaped silicone grill cover 200, any of holes located at any location along the edge of the cover 200 is contemplated. In one embodiment, the holes 202 may be punched out of the silicone rubber sheet at the time the silicone sheet is die-cut, and may not be reinforced by any additional means. In another embodiment, the holes 202 may be punched out of the silicone sheet and may also be reinforced with metal collars within the holes 202 (i.e., grommets). In addition, the holes 202 may be reinforced with collars made of the same silicone polymer from which the silicone grill cover 200 is comprised.

Although not specifically shown in FIG. 2A, the silicone grill cover 200 may be secured to the grill 100 by threading rope, chains, elastic cords or hooks into and through the holes 202 and around different portions of the grill 100, such as around the legs 106.

In another embodiment, grill cover 200 may be secured to the grill by way of magnets embedded within the silicone polymer. In particular, FIG. 2B shows grill cover 200, with pockets 208 around the edges. Pockets 208 may extend along the length of each edge of the silicone grill cover 200, or pockets 208 may be smaller, and placed at a plurality of different locations within the silicone grill cover 200, such as on the corners, or spaced along the edges. One or more magnets may be placed within the pockets such that when the silicone grill cover 200 is draped over the grill 100, the magnets are attracted to the magnetic portions of the grill 100, securing the silicone grill cover 200 to the grill 100. In another embodiment, the magnets 206 may be located along the grill cover, and distributed in such a way, so that the magnets attract one another and the grill cover secures to the grill by the grill cover magnets attracted to other magnets coupled to the silicone grill cover 200.

In yet another embodiment, as shown in FIG. 2C, silicone grill cover 200 may comprise a plurality of silicone polymer fingers 204 extending from at least one edge the sheets. In this embodiment, silicone polymer fingers 204 may be cut out of the same sheet of silicone polymer such that the grill cover 200 and the fingers 204 are made from one piece of silicone rubber. In other words, the fingers 204 and the main portion of silicone grill cover 200 are one piece of silicone polymer.

The fingers 204 may wrap around elements of the grill, and be tied to each other to secure the silicone grill cover 200 to the grill 100. For example, the fingers 204 may wrap around any element of the grill 100 (e.g., the grill legs 106, shelves 108, or top cover handle 110), and then the fingers 204 are tied to each other in order to secure the silicone grill cover 200 to the grill 100. In another example, In addition, the fingers 204 may individually tie to elements of the grill itself to secure the silicone grill cover 200 to the grill 100.

In another embodiment, while the fingers 204 may be configured to tie together or to tie to elements of the grill 100 for securing, magnets 206 may be coupled to the fingers 204, so that the fingers 204 may secure either to another finger or to a magnetic portion of the grill 100 by way of magnetic attraction. In yet another embodiment, snap fasteners 210 may be coupled to the fingers 204 so that the silicone grill cover 200 may be secured by snap fastening the fingers 204 to each other, or to elements of the grill 100.

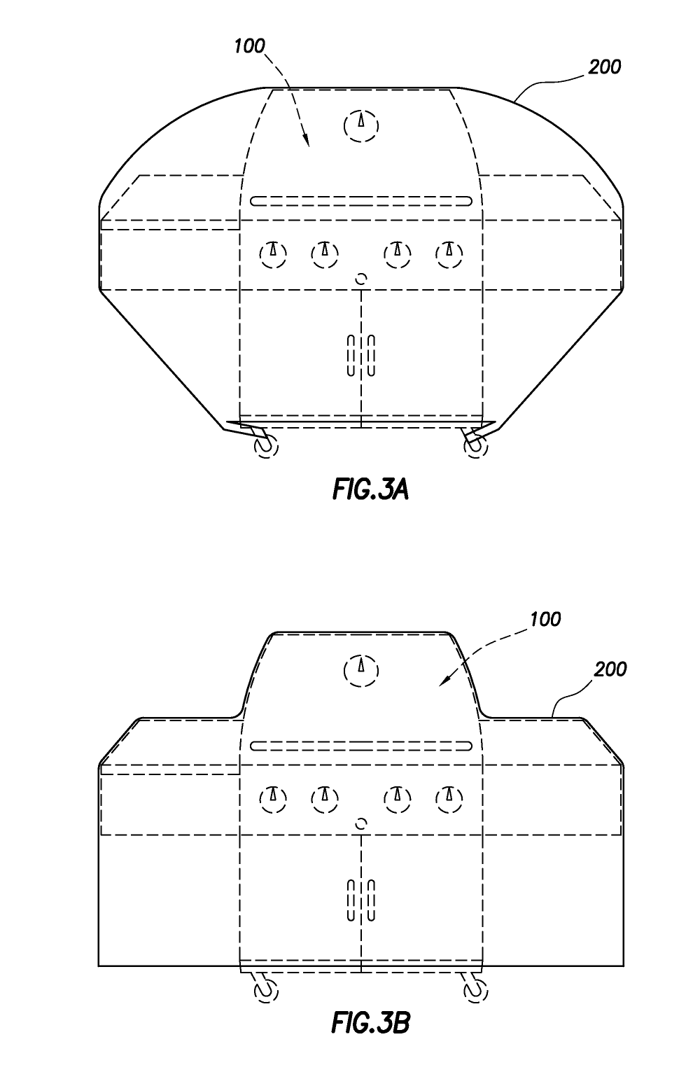

FIG. 3A shows an example embodiment in which grill 100 (shown in dotted lines), has been covered by draping silicone grill cover 200 over the grill. In this example embodiment, silicone grill cover 200 is a polygonal sheet which has been attached at the grill legs 104. Because the silicone grill cover is not specifically made for the shape of grill 100, there may be portions of the grill which do not touch portions of the silicone grill cover and vice versa. In this embodiment, the polygonal silicone grill cover may have been made by way of rolling our sheet of silicone polymer and cutting it to predetermined specifications; however, in another embodiment, the silicone polymer may be custom molded or shaped so that it conforms to the shape of specific grill brands or specifications. In the custom shaped embodiments, a larger portion of the surface area of the silicone grill cover 200 will cover a larger portion of the surface area of the silicone grill cover 200, as can be seen in FIG. 3B.

In addition to custom molding and shaping, the silicone grill covers may be produced in a variety of custom colors, or may be screen printed with a variety of custom or licensed designs for personalization. In another embodiment, logos or custom artwork may be three-dimensionally modeled into the silicone material of the silicone grill cover.

While the specification has discussed a high-temperature resistant silicone grill cover, the cover need not be used solely for the purposes of covering an outdoor grill. Other cooking apparatuses may be contemplated such as: a gas grill, a charcoal grill, a toaster, a toaster oven, a charcoal grill, a hibachi, and an indoor cooking range.

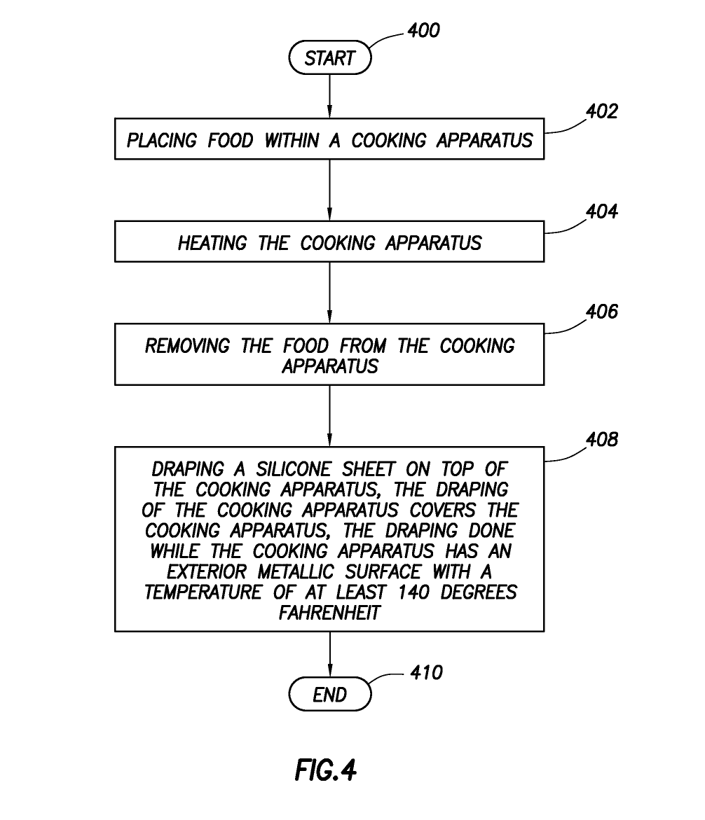

The method of covering a cooking device with a silicone sheet will now be discussed in more detail. FIG. 4 shows a flow diagram depicting an overall method of covering a heated cooking apparatus. The method starts (block 400) by heating a cooking apparatus (block 402); and moves to placing food within the cooking apparatus (block 404); then removing the food from the cooking apparatus (block 406); and then draping a silicone sheet on top of the cooking apparatus, the draping of the silicone sheet covers the cooking apparatus, the draping done while the cooking apparatus has an exterior metallic surface with a temperature of at least 140 degrees Fahrenheit (block 408). Thereafter, the method ends (block 410).

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
heating a cooking apparatus;
placing food within the cooking apparatus;
removing the food from the cooking apparatus; and then
draping a silicone sheet on top of the cooking apparatus, the draping of the silicone sheet covers the cooking apparatus, the draping done while the cooking apparatus has an exterior metallic surface with a temperature of at least 140 degrees Fahrenheit.

2. The method of claim 1 further comprising securing the silicone sheet to the cooking apparatus.

3. The method of claim 2 wherein securing the silicone sheet to the cooking apparatus is by way of at least one selected from the group comprising: magnetically; tying the silicone sheet to the cooking apparatus by way of at least one tie laced through at least one hole punched through the silicone sheet; snaps; and buttons.

4. The method of claim 1 wherein draping the silicone sheet on top of the cooking apparatus further comprises draping the silicone sheet on top of a gas grill.

5. The method of claim 1 wherein draping the silicone cover on top of the cooking apparatus further comprises draping the silicone sheet on top of an electric grill.

6. The method of claim 1 wherein draping the silicone cover on top of the cooking apparatus further comprises draping the silicone cover on top of an electric toaster oven.

7. The method of claim 1 wherein draping the silicone cover on top of the cooking apparatus further comprises draping the silicone cover on top of a cooking range.

8. A system comprising:
a polygonal sheet of silicone polymer;
a plurality fingers extending from at least one edge of the polygonal sheet, the fingers comprised of the silicone polymer;
wherein the polygonal sheet is configured to drape on top of a cooking apparatus; and
wherein the plurality of fingers are configured to secure the polygonal sheet of silicone polymer to the cooking apparatus.

9. The system of claim 8 wherein the polygonal sheet has a melting point of no less than 750 degrees Fahrenheit.

10. The system of claim 8 wherein the plurality of fingers further comprises at least one magnet.

11. The system of claim 8 wherein the plurality of fingers further comprises at least one snap fastener.

12. A system comprising:
a sheet of silicone polymer;
an attachment apparatus located at least one edge of the sheet, the attachment apparatus configured to secure the sheet to an appliance.

13. The system of claim 12 wherein the attachment apparatus is a hole in the sheet.

14. The system of claim 13:
wherein the hole further comprises a reinforcing collar; and
wherein the reinforcing collar is comprised of at least one selected from the group consisting of: silicone polymer; and metal.

15. The system of claim 12 wherein the attachment apparatus is at least one strap.

16. The system of claim 12 wherein the strap is threaded through a hole in the sheet

17. The system of claim 15 wherein the at least one strap further comprises at least one magnet coupled to the strap.

18. The system of claim 12 wherein the attachment apparatus is a magnet.
